(19) United States
(12) Patent Application Publication
(10) Pub. No.: US 2026/0161542 A1
(43) Pub. Date: Jun. 11, 2026

(54) MECHANISM TO PROTECT A PROCESSOR’S SECURITY MODEL WHILE ALLOWING TRADITIONAL UNSAFE PRACTICES WITHIN A BOUNDED MEMORY RANGE

(71) Applicant: Unisys Corporation, Blue Bell, PA (US)

(72) Inventors: Andrew Ward BEALE, Carolina Shores, NC (US); David STRONG, Irvine, CA (US); Steven Anthony Ramirez Rosa, Linthicum Heights, MD (US)

(21) Appl. No.: 18/970,594

(22) Filed: Dec. 5, 2024

(51) Int. Cl. G06F 12/02; G06F 21/54

(52) U.S. Cl. CPC G06F 12/023; G06F 21/54; G06F 2221/034

(57) ABSTRACT

In various examples, a new type, <RAW>, is allocated to supply a sequential range of addresses in a Secure Migratable Architecture (SMART). The compiler may perform address calculations that correctly refer to the lowest byte of an item and allow for items of any length to be read or written within the boundaries of the RAW buffer. Each buffer in SMART is bounds checked, which prevents a buffer overrun attack vector at the architectural level. In this way, the SMART processor itself prevents memory allocations from being accessed beyond their bounds.

### BACKGROUND

In the context of processor architecture, programming languages, and compiler code generation, the conventional approach of generating an intermediate representation from which target machine code may be generated for any given processor architecture assumes that a pointer is opaque. This is particularly prevalent in languages such as C and C++, which are often used to closely communicate and work with hardware resources. The pointer is opaque in the sense that the intermediate representation has been stripped of any indication of what the pointer references. It is merely an address or a number, with identical numerical properties as any other numerical value within the processor. This results in a large number of vulnerabilities in the form of buffer overruns, memory snooping, scope violations, and many other approaches which take advantage of raw address generation and modification.

### SUMMARY

Embodiments described herein include methods and systems for enabling opaque addresses in a Secure Migratable Architecture (SMART) processor. Embodiments enable the SMART processor to be aware of the fundamental type system and, more importantly, only the SMART processor is aware of the addresses assigned to each memory allocation. In this way, the software running on the processor is unable to acquire the actual address where data and code is stored, while remaining capable of reading (if allowed) and writing (if allowed) bytes of data visible to the software. Accordingly, the physical address is opaque in that it may be referenced, but its location is not obtainable.

Additionally, embodiments described herein include methods and systems for enabling optimizations in a SMART architecture. To do so, a new type, <RAW>, is allocated to supply a sequential range of addresses. The compiler may perform address calculations that correctly refer to the lowest byte of an item and allow for items of any length to be read or written within the boundaries of the RAW buffer. Each buffer in SMART is bounds checked, which prevents a buffer overrun attack vector at the architectural level. In this way, the SMART processor itself prevents memory allocations from being accessed beyond their bounds.

### BRIEF DESCRIPTION OF THE DRAWINGS

The present disclosure is described in detail below with reference to the attached drawing figures, wherein:

FIG. 1 is a block diagram illustrating an exemplary system, in accordance with some implementations of the present disclosure;

FIGS. 2-27 depict example SMART instruction sequences and the corresponding characteristics of raw storage, in accordance with some implementations of the present disclosure;

FIG. 28 depicts an example process flow for enabling opaque addresses in SMART processor, in accordance with some implementations of the present disclosure;

FIG. 29 depicts an example process flow for enabling optimizations in a SMART architecture, in accordance with some implementations of the present disclosure; and

FIG. 30 is a block diagram of an exemplary computing environment suitable for use in implementations of the present disclosure.

### DETAILED DESCRIPTION

The SMART processor provides security at the processor level beyond the capabilities of conventional processors. Various implementations of SMART are described in U.S. Pat. Nos. 9,760,291, 9,817,580, 9,823,851, and 9,965,192, which are incorporated herein by reference in the entireties, except for any definitions, subject matter disclaimers or disavowals, and except to the extent that the incorporated material is inconsistent with the express disclosure herein, in which case the language in this disclosure controls.

Aspects of the technology described herein provide a number of improvements over existing technologies. For example, in a SMART processor, the type system is incorporated into the architecture. Each reference (i.e., pointer) that is created is of a known type. Moreover, each type has a geometry defining the amount of storage (i.e., memory) required to represent entities of that type. For example, an unsigned 8-bit integer requires one byte of storage. In another example, a signed 64-bit integer requires eight bytes of storage.

This structure enables the SMART processor to be aware of the fundamental type system and, more importantly, only the processor is aware of the addresses assigned to each memory allocation. In other words, the software running on the processor is unable to acquire the actual address where data and code is stored, while remaining capable of reading (if allowed) and writing (if allowed) bytes of data visible to the software. Accordingly, the physical address is opaque in that it may be referenced, but its location is not obtainable. The opaque address presents a significant enhancement to security because addresses may not be created and dereferenced purely by interpreting a numerical value. Rather, data may be accessed only through a legitimately created reference, to an area of known geometry and bounds. As the opaque address is enforced by the processor, it is much more difficult to circumvent.

Although the distinction between an opaque pointer and an opaque address is subtle, it is indeed distinct. For example, memory allocation is no longer a function of the operating system. Rather, it is a function of the firmware (or the processor itself). Initially, an instruction is used to allocate a sequential piece of memory in the available virtual address space. Each memory segment that is allocated is tagged in a way that indicates the underlying architecture of the data contained within the segment. In some aspects, compilers may retain and leverage type information during code generation when type information is available to the back-end code.

In some aspects, an area descriptor describes a specific memory segment. For example, an area descriptor may be allocated via an ALLOC instruction. The ALLOC instruction allocates the buffer where data can be placed. A CLONE instruction, on the other hand, is allocated a new, unique area descriptor token that refers to the buffer. As a result, an area descriptor token is returned from both instructions. For clarity, multiple CLONES may refer to the underlying buffer with different views of the same data, but all are bounds checked against their view of the buffer.

The instruction may be provided with an indication as to how the tags of the area are to be represented. In this regard, the assigned tag is part of the data associated with the area descriptor token. It is not returned in a destination register; rather, it is stored in the storage and used for attributes of the descriptor. Importantly, the address is but one of the attributes associated with the descriptor, and there is no instruction which is capable of returning it the software. The processor can access it, but there is no manner to enable its return to the software.

In some aspects, the area descriptor contains the length of the segment as an unsigned positive value. The area descriptor may be an original and own the memory it points to. Or, the area descriptor may be a clone and does not own the memory it points to. But, it may refer to the memory area in a different way than the original (e.g., data casting).

In some aspects, area descriptor tokens may be a 64-bit binary value which have a one-to-one correspondence with a memory segment allocated by the firmware. Area descriptor tokens values may not be re-used. In some aspects, a range of area descriptor token values (e.g., low numbered values) are reserved for special purposes including the boot process.

In some aspects, an area descriptor collection is a set of area descriptor tokens and may be contained in the entity that owns the area descriptor. This may be the associated register context where the ALLOC instruction was executed. In aspects, architectural contexts own their own area descriptors and each context has its own area descriptor collection. This ensures that, when the context is exited, each area descriptor owned by the context also gets deleted. Since area descriptors are not re-used, references to deleted area descriptors are invalid. In contrast, cloned area descriptors do not delete the memory area they reference, as they do not own them. There is a single owner for each area descriptor, and each area descriptor is contained in an area descriptor collection. In this regard, there may be many area descriptor collections and an area descriptor is a member of one of them.

In some aspects, an area descriptor attribute is state associated with a specific area descriptor. An area descriptor attribute describes a specific trait, capability, or other defining characteristic of an area descriptor. For example, memory may have an attribute indicating the address refers to non-volatile memory, read-only memory, control store memory, holographic memory, or encrypted memory. Area descriptor attributes offer specialization and adaptability to the types of memory and contexts which may be referred to within the architecture.

If the area descriptor is dereferenced, the resulting target address may be bounds checked. In some aspects, the full width of the target must lie within the bounds of the area. The lowest addressed byte of the target must be greater than or equal to the lowest addressed byte of the area into which it is being stored. Similarly, the highest addressed byte must be less than or equal to the highest addressable byte contained within the area into which it is being stored. The offset refers to where the lowest address from the base of the view. If the buffer has a total of eight bytes, and the offset is 6, a read or write is valid for 0, 1, or two bytes. If 3 or more, then the bounds check raises an exception. As long as the dereferenced portion is in bounds, the access is allowed. In this way, the access is allowed to continue, which may include additional checks prior to actual reading or writing of the data (e.g., read only). In contrast, if the bounds check is not met, an exception is raised. Moreover, an attempt to set the offset of a reference below a physical address of 0 or above a physical address of 264 causes an exception to be raised at the time of the attempt, as it is not representable within the architecture.

Conventional commodity processors treat addresses as integers that range from 0 to N, where N is the maximum address available to the processor. Data and code are stored in ranges of memory and allow the processor to execute instructions and perform actions on the data. However, the processor considers everything to be a number: code; data; and addresses. Consequently, attack vectors may exploit this characteristic. Moreover, compilers leverage this to optimize the number of loads and stores knowing that it can read and write adjacent items with impunity because the pointers are opaque. The compiler does not need to know what it points to, only that there are adjacent entities which can be accessed as a single larger item to reduce the amount of time it takes the processor to execute the code.

By way of example, C and other language compilers often make optimizations to increase performance and reduce execution time. As shown in Example 1, consider the case of a C structure which has multiple elements:

struct S1 {
int f0;
int f1;
int f2;
};

### Example 1

Assuming an int consumes 4 bytes of storage, f0, f1, and f2 combined consume 12 bytes of storage at consecutive addresses. Also, assuming f0 resides at address 0x1000, the address ranges of each variable is listed in the following table:

| | | |
|---|---|---|
| f0 | 0x1000 | 0x1003 |
| f1 | 0x1004 | 0x1007 |
| f2 | 0x1008 | 0x100B |

In another example, a compiler which encounters the C statements illustrated in Example 2 may choose to emit unoptimized code which stores each value as a separate 32-bit store. However, if the processor supports 64-bit loads and stores, the compiler may optimize the sequence to be a single store of a 64-bit value, combining the two 32-bit values into the proper 64-bit value, allowing the single store to write both integer values. It does this because it knows these two items are at adjacent addresses.

struct S2 {
char f0;
int f1;
char f2;
char f3;
char f4;
};

### Example 2

Code that initializes these five items in sequence may be optimized into a single 64-bit write. Since pointers are opaque to the compiler in the sense that they are just numbers, the 64-bit capability of a CPU may be utilized to manipulate multiple data items which are adjacent to each other. This is a valid performance optimization technique in commodity processors.

As shown below in Example 3, the structure occupies 12 bytes (e.g., 1+8+1+1+1) of adjacent storage in a processor that supports 64-bit pointers. The integer pointer f1 consumes 8 bytes within the range of addresses for S3 in a commodity processor. Further, a character pointer may be advanced byte by byte allowing the individual bytes of the pointer to be read or written. However, this type of access violates the security model provided by SMART.

struct S3 {
char f0;
int* f1;
char f2;
char f3;
char f4;
};

### Example 3

In contrast, in aspects described herein, the SMART processor is an architecture which pushes the type system, as well as memory management, into the processor itself. The processor is aware of the type of any instance of data. Datum is no longer just a number (as in commodity processors); rather, it has an associated type.

The SMART processor also utilizes opaque addresses, in the sense that a memory reference is a token, and the processor itself knows what address(es) a token refers to. Further, software executing on a SMART processor is incapable of acquiring the address of any item. Instead, all items are accessed via the tokens assigned to their memory ranges.

In Example 1 above, in a SMART processor, structure S1 has the type <STRUCT> and contains 3 items, each of which is a signed 32-bit value, represented as a <S32> as the type in SMART. The structure S1, when allocated, is provided a token which represents the buffer or storage which will contain data items within S1. Although the address of each item is opaque, offsets may be applied to a token's base to access individual items. But, items are not guaranteed to reside at sequential addresses. Even though the processor is aware of the geometry of the types and how each is laid out, the software has no perception of where or how any data is stored. Thus, access is achieved only via the associated token plus offset for entities which reside in memory. Unfortunately, this attribute of SMART architecture invalidates a large class of useful optimizations from compilers which exist today (LLVM).

Referring now to Example 3 above, in a SMART processor, f1 is a unique 8-byte token, which once allocated, is immutable. The item f1 will reside in S3[1] (i.e., item 1 of S3 as items are 0 based) and contains a Reference Area Descriptor Token <RADT> that informs the SMART processor of the type of data. Reading f1 in any manner but its entirety raises an exception in the SMART processor. Additionally, writing f1 in any manner but its entirety also raises an exception in the SMART processor. Accordingly, SMART processors are unable to take advantage of a wide range of optimizations utilizing opaque pointers in an opaque address environment.

Additionally, aspects of the technology described herein enable a method for compilers to perform optimizations in a SMART environment, while allowing the SMART processor to preserve the security model. As a result, security is provided at the hardware level shutting down a primary attack vector in commodity processors.

To do so, a new type, <RAW>, is allocated to supply a sequential range of addresses. In this way, the compiler may perform address calculations that correctly refer to the lowest byte of an item and allow for items of any length to be read or written within the boundaries of the RAW buffer. Each buffer in SMART is bounds checked, which prevents a buffer overrun attack vector at the architectural level. In other words, the SMART processor itself prevents memory allocations from being accessed beyond their bounds.

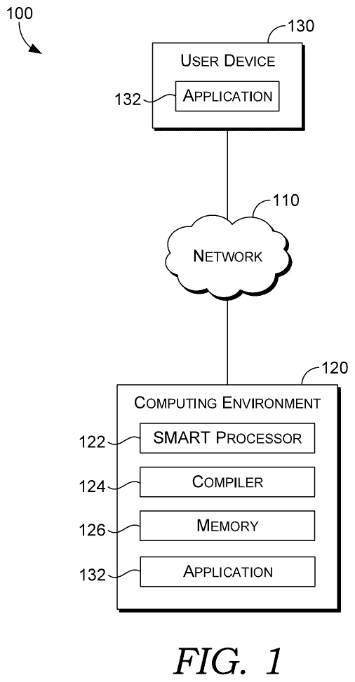

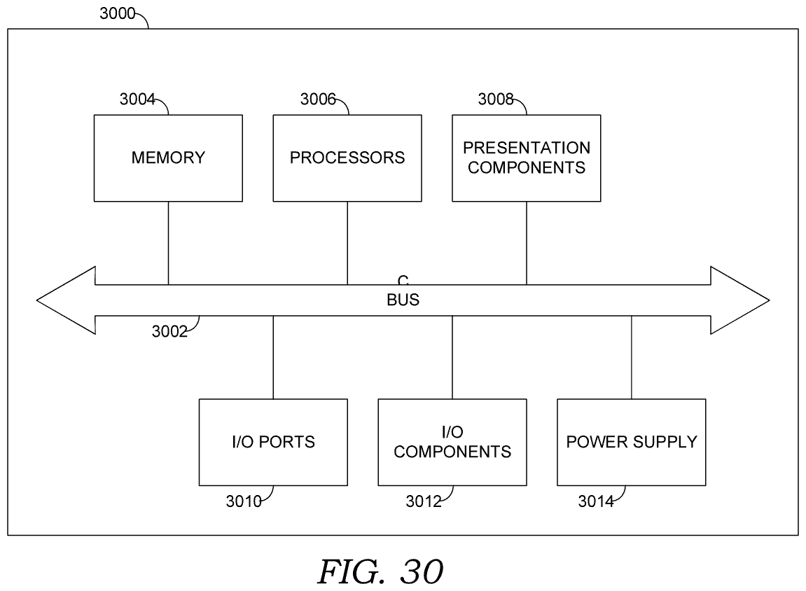

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory, as further described with reference to FIG. 30.

It should be understood that operating environment 100 shown in FIG. 1 is an example of one suitable operating environment. Among other components not shown, operating environment 100 includes a user device 130, a computing environment 120, and a network 110. Each of the components shown in FIG. 1 can be implemented via any type of computing device, such as one or more computing devices 3000 described in connection with FIG. 30, for example. These components can communicate with each other via network 110, which can be wired, wireless, or both. Network 110 can include multiple networks, or a network of networks, but is shown in simple form so as not to obscure aspects of the present disclosure. By way of example, network 110 can include one or more wide area networks (WANs), one or more local area networks (LANs), one or more public networks such as the Internet, and/or one or more private networks. Where network 110 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 110 is not described in significant detail.

It should be understood that any number of devices, servers, and other components can be employed within operating environment 100 within the scope of the present disclosure. Each can comprise a single device or multiple devices cooperating in a distributed environment. For example, the computing environment 120 may include multiple server computer systems cooperating in a distributed environment to perform the operations described in the present disclosure.

User device 102 can be any type of computing device capable of being operated by an entity (e.g., individual or organization) and and/or developer and may obtain data from memory 126 which can be facilitated by the computing environment 120. The user device 102, in various embodiments, has access to or includes application 132 (in some aspects, components of the application may reside on the user device 102, the computing environment 120, or a combination thereof).

As illustrated in FIG. 1, computing resources within the computing environment 120 include SMART processor 122, compiler 124, and memory 126, and may be used to execute instructions of application 132. The application 132 may include instructions that are compiled using the compiler 124 to read and/or write data in memory 126, based on the architecture of the SMART processor 122.

For example, the application 132 may include instructions to allocate a <RAW> buffer in memory 126. When a <RAW> buffer is allocated, each item is a byte. Additional types in SMART which are allocated in bytes are <U8> (i.e., an unsigned 8-bit value) and <S8> (i.e., a signed 8-bit value). The <RAW> type is essentially a degenerate form of <U8>. In <U8> buffer, only 8-bit unsigned items may be loaded or stored. In contrast, in a <RAW> buffer, any item type may be read or written into a range of adjacent bytes, provided that the SMART security model is not violated, including protection for a range of 8-bit items which are of the <RADT> type.

The protections for the contents of <RAW> memory is based on a parallel allocation of memory which provides a “Shadow Type” indicator. The “Shadow Type” indicator tracks the types of items which are stored in the <RAW> area. Since all types outside of the <RAW> area are known to the SMART processor, the SMART processor tracks what was last written into each byte of <RAW> storage. This allows the processor to enforce the security model on all loads and stores into <RAW> storage. When an item is loaded from <RAW> into a register or alternate storage type, the processor validates the type to be assigned to the loaded item does not violate the SMART security model in any way.

If a violation is detected, an exception is raised on the instruction executing the load. This allows a developer to isolate the security vulnerability and develop a fix. In the case where the developer determines that what is being attempted is necessary and legal from a language perspective, it remains a violation of the security afforded by the SMART processor, and the developer is encouraged to target the application to alternate commodity processors which do not provide the security at the architecture level. Accordingly, the SMART architecture provides a secure processing environment capable of running traditional unsafe languages in a safe environment.

In some implementations, user device 102 is the type of computing device described in connection with FIG. 30. By way of example and not limitation, the user device 102 can be embodied as a personal computer (PC), a laptop computer, a mobile device, a smartphone, a tablet computer, a smart watch, a wearable computer, a personal digital assistant (PDA), a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors and one or more computer-readable media. The computer-readable media can also include computer-readable instructions executable by the one or more processors. In an embodiment, the instructions are embodied by one or more applications, such as application 132 shown in FIG. 1. Application 132 is referred to as a single application for simplicity, but its functionality can be embodied by one or more applications in practice.

In various embodiments, the application 132 includes any application capable of facilitating the exchange of information between the user device 102 and the computing environment 120. In an example, the application 132 may allow the user device 102 to communicate and/or execute instructions using computing resources of the computing environment 120 to read and/or write data into memory 126.

In some implementations, the application 132 comprises a web application, which can run in a web browser, and can be hosted at least partially on the server-side of the operating environment 100. In addition, or instead, the application 132 can comprise a dedicated application, such as an application being supported by the user device 102 and the computing environment 120. In some cases, the application 132 is integrated into the operating system (e.g., as a service). It is therefore contemplated herein that “application” be interpreted broadly.

For cloud-based implementations, for example, the application 132 is utilized to interface with the functionality implemented by the computing environment. In some embodiments, the components, or portions thereof, of a developer computing environment (not shown in FIG. 1) are implemented within the computing environment 120 or other systems or devices. For example, the compiler 124 is executed within the computing environment 120. In addition, it should be appreciated that the computing environment 120 and the user device 102, in some embodiments, are provided via multiple devices arranged in a distributed environment that collectively provide the functionality described herein. Additionally, other components not shown can also be included within the distributed environment.

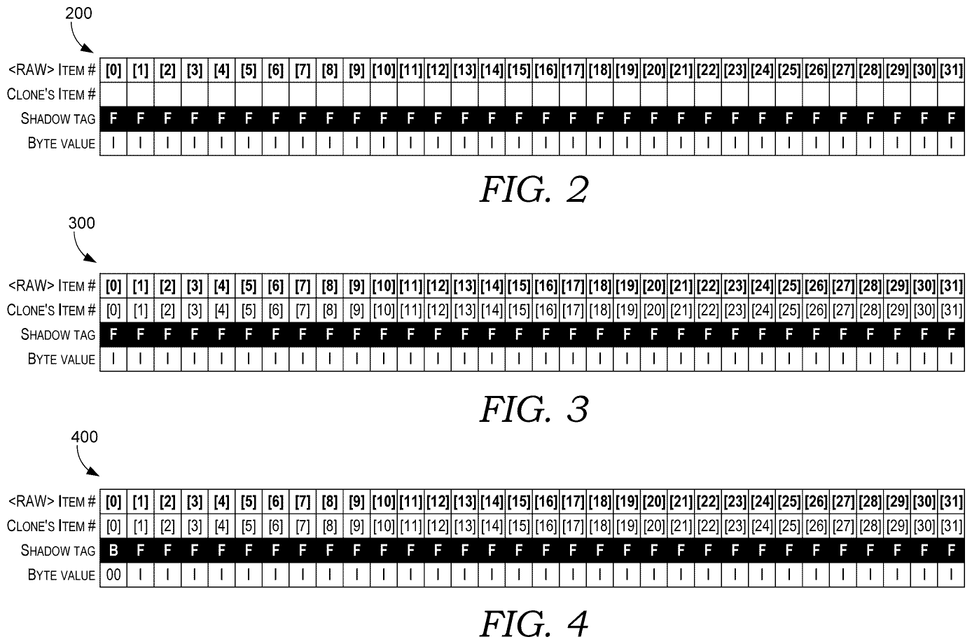

FIGS. 2-27 depict example SMART instruction sequences and the corresponding characteristics of raw storage, in accordance with some implementations of the present disclosure. For clarity, the rows of FIGS. 2-27 are represented (from top to bottom) by: <RAW> item #, CLONE item #, shadow tag, and byte value. Moreover, the shadow tags are defined by the following: F=<FWINIT>; B=byte; *R=least significant byte (LSB) of <RADT>; R=not LSB of <RADT>. Additionally, the byte values are hexadecimal (hex) and I=<FWINIT> implementation value. For purposes of these examples, it is assumed that all registers exist and when exceptions are thrown they are ignored and execution continues to the next instruction. In this regard, these examples are for illustration purposes and to allow for the continuous flow of the examples.

Initially, in FIG. 2, as executed by the instructions below, the first instruction assigns the defined tag value for <RAW> into the GP8 register. The second instruction indicates a <RAW> area of 32 bytes is desired. Finally, the third instruction allocates the <RAW> area of 32 bytes and specifies GP0 as the buffer <RADT>. The resulting <RAW> item #s, CLONE item #s, shadow tags, and byte values are illustrated by 200.

LTRL GP8, <U8> 0x1C
LTRL GP9, <U8> 0x20
ALLOC GP0, GP8, GP9

Next, as executed by the instruction below and referring now to FIG. 3, the buffer is cloned to provide an item view. Recall buffers are storage only. GP1 is a CLONE which refers to <RAW> items stored in the buffer, GP0. Put another way, a CLONE of the buffer GP0 refers to is created and the new <RADT> is stored into the GP1 processor register. The CLONE's offset is set to 0 upon creation. The resulting <RAW> item #s, CLONE item #s, shadow tags, and byte values are illustrated by 300.

### CLONE GP1, GP0

In FIG. 4, a 0 is stored in the location GP1 currently points, as executed by the instruction shown below. Since no IVIEW has been performed, the tag associated with the CLONE's view is the same as that from which it was cloned or, in this case, <RAW> (which is <U8>). The resulting <RAW> item #s, CLONE item #s, shadow tags, and byte values are illustrated by 400.

### LTRL GP1.PTR, <U8>0x00

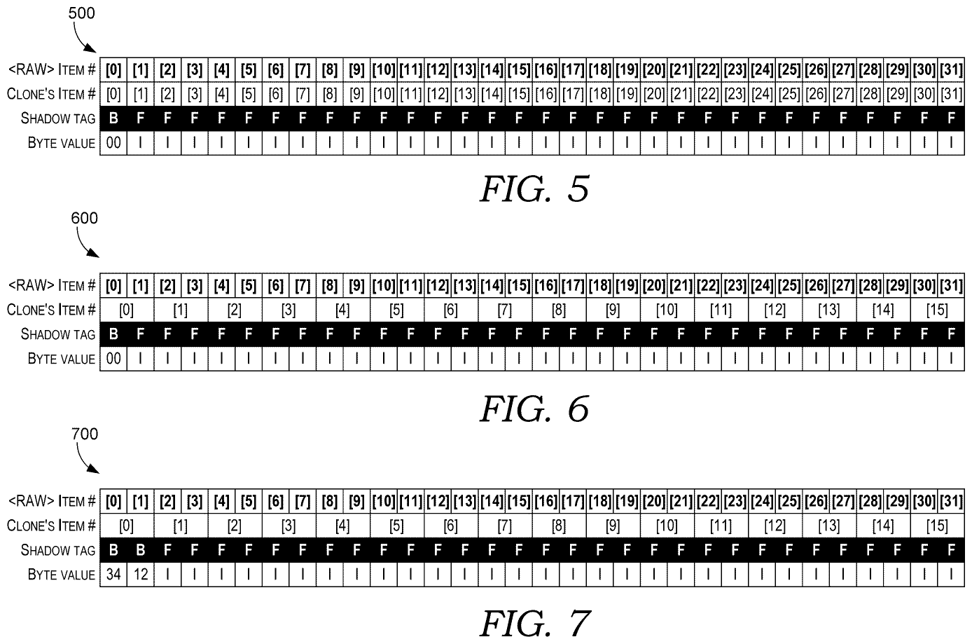

Referring now to FIG. 5, as executed by the instruction below, an attempt to store a 16-bit literal via the CLONE into the current offset (i.e., 0) is issued. Since the tag associated with the CLONE is <RAW> (which is <U8>) and the 16-bit value is too large to store into a <U8>, an exception is raised. In other words, the store is not performed due to the exception. The resulting <RAW> item #s, CLONE item #s, shadow tags, and byte values are illustrated by 500. LTRL GP1.PTR, <U16>0x1234

Next, in FIG. 6, as executed by the instructions below, the first instruction changes the tag of every item within CLONE to <U16>. The second instruction changes the tag of every item and affects the width of every item starting from item [0] through the entire length within the view of CLONE. The resulting <RAW> item #s, CLONE item #s, shadow tags, and byte values are illustrated by 600.

| | |
|---|---|
| LTRL | GP8, <U8> 0x82 |
| ITYPE | GP1, GP8 |

As executed by the first instruction below, the current item GP1 points to (i.e., [0]) is attempted to be moved into GP3. Since one of the bytes referred to in the item is <FWINIT>, an exception is raised. Thus, GP3 is not changed due to the exception. However, ignoring this exception, and as executed by the second instruction below, a 16-bit value is stored into the current item of CLONE because the CLONE's view sees 16-bit items and the bytes are written in little endian order. The resulting <RAW> item #s, CLONE item #s, shadow tags, and byte values are illustrated in FIG. 7 by 700.

| | |
|---|---|
| MOV | GP3, GP1.PTR |
| LTRL | GP1.PTR, <U16>0x1234 |

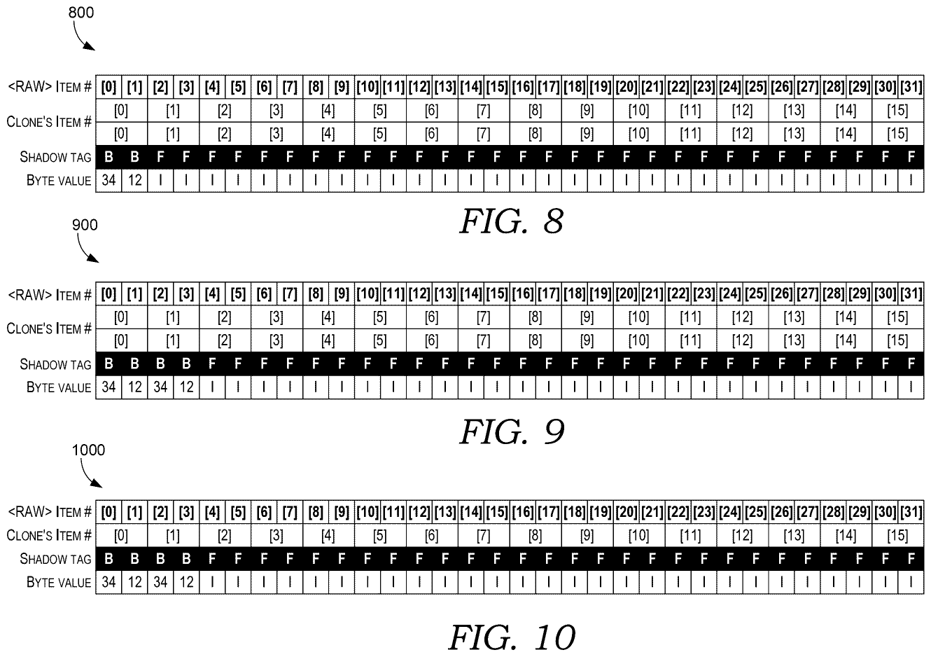

Now, and referring to FIG. 8, as executed by the instruction below, GP1 is cloned into GP2 because GP2 sees the area identically as GP1. In other words, the same 16-bit view is cloned (stored) into GP2 because the CLONE's view also sees 16-bit items and the bytes are also written in little endian order. As illustrated, a second CLONE view has been added to the view. The resulting <RAW> item #s, CLONE item #s, shadow tags, and byte values are illustrated by 800.

### CLONE GP2, GP1

In FIG. 9, as executed by the instructions below, the first instruction causes the offset of GP2 to be incremented (from 0 to 1 in this example). The next instruction causes the item pointed to by GP1 to be moved to GP2 (in accordance with the item pointed to by GP2, after the offset has been incremented. Note, these instructions did not alter any register state. The resulting <RAW> item #s, CLONE item #s, shadow tags, and byte values are illustrated by 900.

INCOFF GP2
MOV GP2.PTR, GP1.PTR

Turning now to FIG. 10, as executed by the instructions below, GP2 is freed. Although optional, this instruction illustrates that after GP2 has been freed or overwritten, the <RADT> that was in GP2 is no longer valid. The resulting <RAW> item #s, CLONE item #s, shadow tags, and byte values are illustrated by 1000.

### FREE GP2

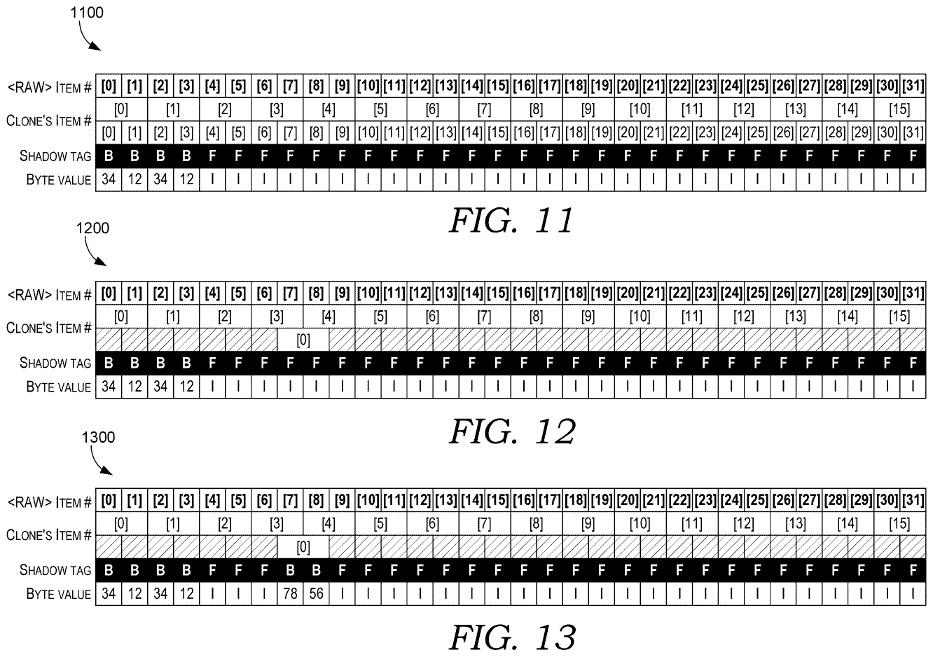

As shown in FIG. 11, as executed by the instruction below, GP0 (original view) is cloned and the <RADT> of the clone is stored in GP2. The resulting <RAW> item #s, CLONE item #s, shadow tags, and byte values are illustrated by 1100.

### CLONE GP2, GP0

Next, as shown in FIG. 12, as executed by the instructions below, the first instruction defines a tag of <U16>. The second instruction indicates the new view should begin at current item [7]. The third instruction indicates the view should contain one item only. Finally, the fourth instruction establishes a new view for GP2. The resulting <RAW> item #s, CLONE item #s, shadow tags, and byte values are illustrated by 1200.

| | |
|---|---|
| LTRL | GP8, <U8> 0x82 |
| LTRL | GP9, <U8> 0x07 |
| LTRL | GP10, <U8> 0x01 |
| IVIEW | GP2, GP8, GP9, GP10 |

In FIG. 13, as executed by the instruction below, a 16-bit literal is stored into the current item of GP2. The resulting <RAW> item #s, CLONE item #s, shadow tags, and byte values are illustrated by 1300.

### LTRL GP2.PTR, <U16>0x5678

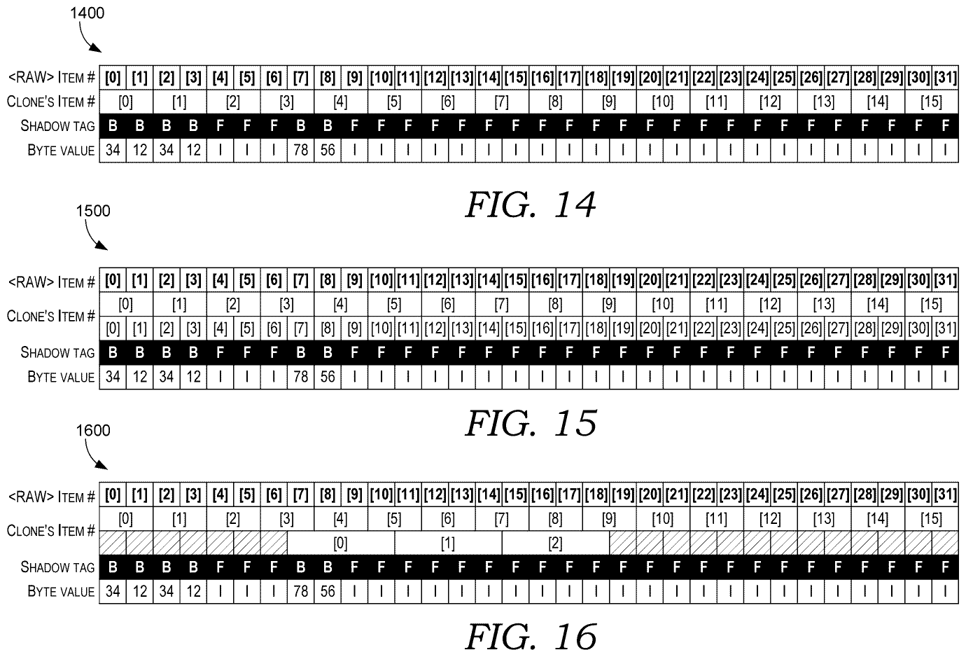

Referring to FIG. 14, as executed by the instructions below, the first instruction advances the offset of GP2 by one item. Even though it is out of bounds, it is not yet dereferenced and no exception is raised. However, the second instruction raises an exception because GP2 refers to item 1 which is now out of bounds. The third instruction frees GP2. The resulting <RAW> item #s, CLONE item #s, shadow tags, and byte values are illustrated by 1400.

| | |
|---|---|
| INCOFF | GP2 |
| MOV | GP2.PTR, GP1.PTR |
| FREE | GP2 |

In FIG. 15, as executed by the instruction below, GP0, which is the initial <RAW> buffer, is cloned and the new <RADT> is stored into GP2. The resulting <RAW> item #s, CLONE item #s, shadow tags, and byte values are illustrated by 1500.

### CLONE GP2, GP0

As shown in FIG. 16, as executed by the instructions below, the first instruction defines a tag of <S32>. Next, the second instruction indicates the new view begins at current item [7]. The third instruction indicates the view should contain 3 items. Finally, the fourth instruction establishes a new view for GP2. The resulting <RAW> item #s, CLONE item #s, shadow tags, and byte values are illustrated by 1600.

| | |
|---|---|
| LTRL | GP8, <U8> 0x87 |
| LTRL | GP9, <U8> 0x07 |
| LTRL | GP10, <U8> 0x03 |
| IVIEW | GP2, GP8, GP9, GP10 |

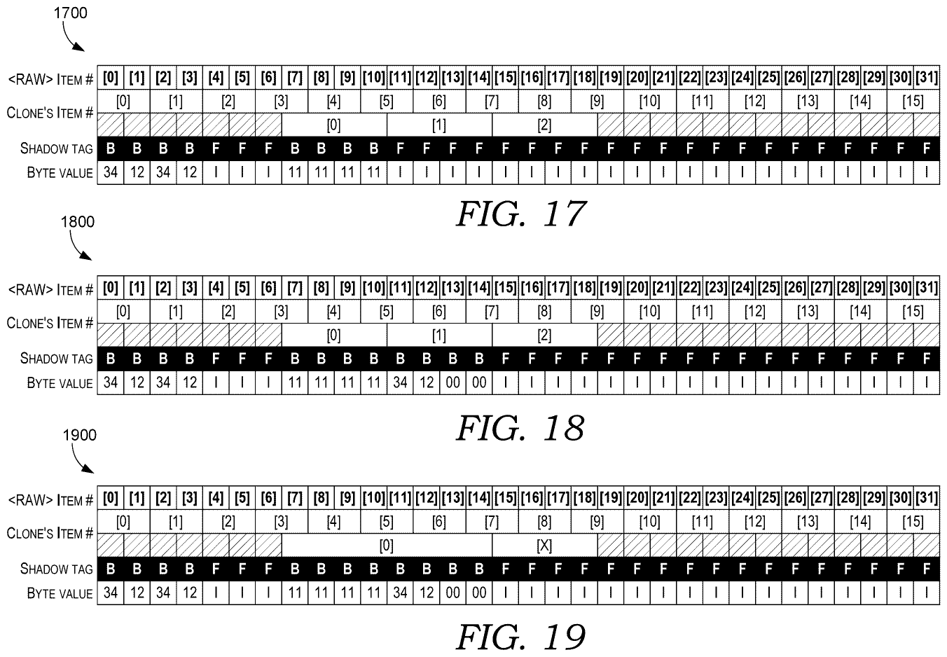

Referring to FIG. 17, and as executed by the instruction below, the value of 0x11111111 is stored where GP2 currently points. The resulting <RAW> item #s, CLONE item #s, shadow tags, and byte values are illustrated by 1700.

LTRL GP2.PTR, 0x11111111

Turning to FIG. 18, and as executed by the instructions below, the first instruction advances the offset of GP2 by one item. Next, the second instruction causes GP1 to point to [0] in its view. The third instruction moves the value (0x1234) at the current item of GP to the current item of GP2.PTR. Even though the view of the destination is <S32>, the value is cast to <S32> and stored in the item where GP2 currently points. The resulting <RAW> item #s, CLONE item #s, shadow tags, and byte values are illustrated by 1800.

INCOFF GP2
CLROFF GP1
MOV GP2.PTR, GP1.PTR

Referring to FIG. 19, and as executed by the instructions below, the first instruction defines a tag of <U64>. Next, the tag associated with GP2 is changed to <U64>. Note, in FIG. 19, how this instruction alters the geometry of where GP2 currently points. The resulting <RAW> item #s, CLONE item #s, shadow tags, and byte values are illustrated by 1900.

| | |
|---|---|
| LTRL | GP8, <U8> 0x84 |
| ITYPE | GP2, GP8 |

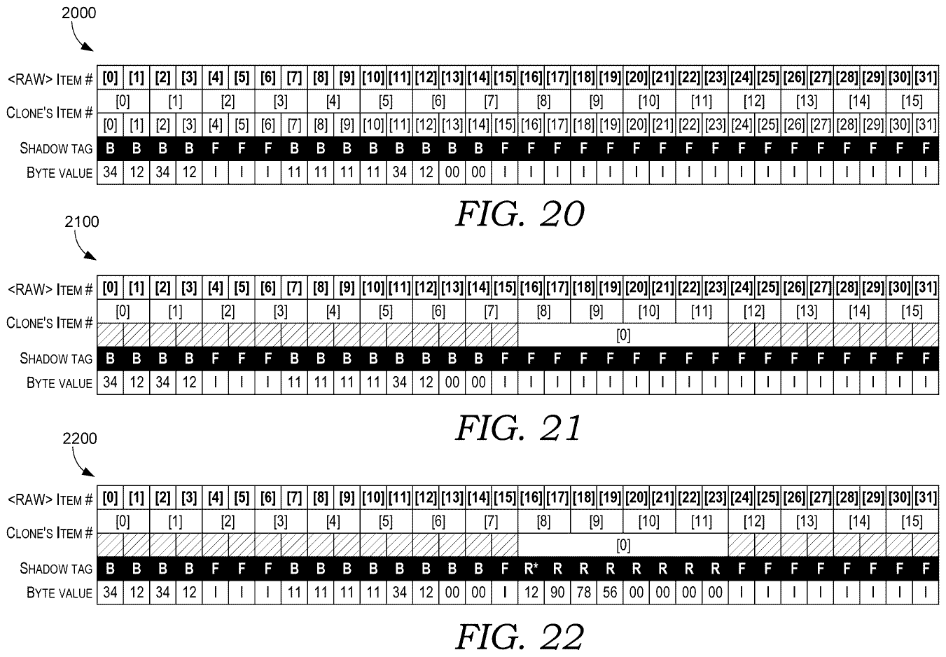

Any attempt to access [1] via the current view results in an exception being thrown. As such, the first instruction below raises an exception as [1] has a portion that is out of bounds. Moreover, it is <FWINT> which generates an exception on read. The second instruction sets the offset of GP2 back to 0. Next, the third instruction causes the value (0x0000123411111111) where GP2 currently points to be stored into GP3. The fourth instruction loads a value of [5] into GP8. Next, the fifth instruction causes GP1 to point to [5] as <U16>. The sixth instruction causes the value (0x3411) where GP1 currently points to be stored into GP3 with a tag of <U16>. Note, GP2 contains the <RADT> of a clone. It has an offset of 0 but its base is at offset 7 of the buffer to which it points. Finally, the seventh instruction reverts this clone to refer to the entire buffer using the tag associated with the allocation, which is <RAW>. Any attempt to access [1] via the current view will result in an exception being thrown. The resulting <RAW> item #s, CLONE item #s, shadow tags, and byte values are illustrated in FIG. 20 by 2000.

| | |
|---|---|
| MOV | GP3, GP2.PTR |
| CLROFF | GP2 |
| MOV | GP3, GP2.PTR |
| LTRL | GP8, <U8> 5 |
| SETOFF | GP1, GP8 |
| MOV | GP3, GP1.PTR |
| NOVIEW | GP2.PTR |

As shown in FIG. 21, and as executed by the instructions below, the first instruction throws an exception. Note, GP1 contains the (<RADT>) of a clone. The instruction attempts to cause the value of GP1 to be stored into where GP2 currently points. GP2 has a tag of <RAW> since it has no IVIEW applied to it anymore. As a <RADT> is an 8-byte item and may not be cast into a <RAW> (or <U8>), and as noted above, the instruction throws an exception. The second instruction defines a tag of <RADT>. Next, the third instruction indicates the view of the buffer starts at [16]. The fourth instruction indicates the view should contain one item only. Finally, the fifth instruction changes GP2's view of the buffer. The resulting <RAW> item #s, CLONE item #s, shadow tags, and byte values are illustrated by 2100.

| | |
|---|---|
| MOV | GP2.PTR, GP1 |
| LTRL | GP8, 0x1B |
| LTRL | GP9, 0x10 |
| LTRL | GP10, 0x1 |
| IVIEW | GP2, GP8, GP9, GP10 |

Turning to FIG. 22, and as executed by the instruction below, <RADT> is a unique 64-bit token. Assuming the value of the GP1 register is <RADT>0x000000000056789012, the instruction causes the value to be stored where GP2 currently points. The tag associated with GP2's view is <RADT> which is required to store <RADT> into a raw area. The processor updates the shadow tags of the bytes written to define the bytes as <RADT>, and the first byte is specially designated. The shadow tags preserve the security boundary provided by <RADT> in that they are immutable. Once an <RADT> is stored into <RAW>, it may be overwritten in its entirety via a clone with a view of <RADT>. The resulting <RAW> item #s, CLONE item #s, shadow tags, and byte values are illustrated by 2200.

### MOV GP2.PTR, GP1

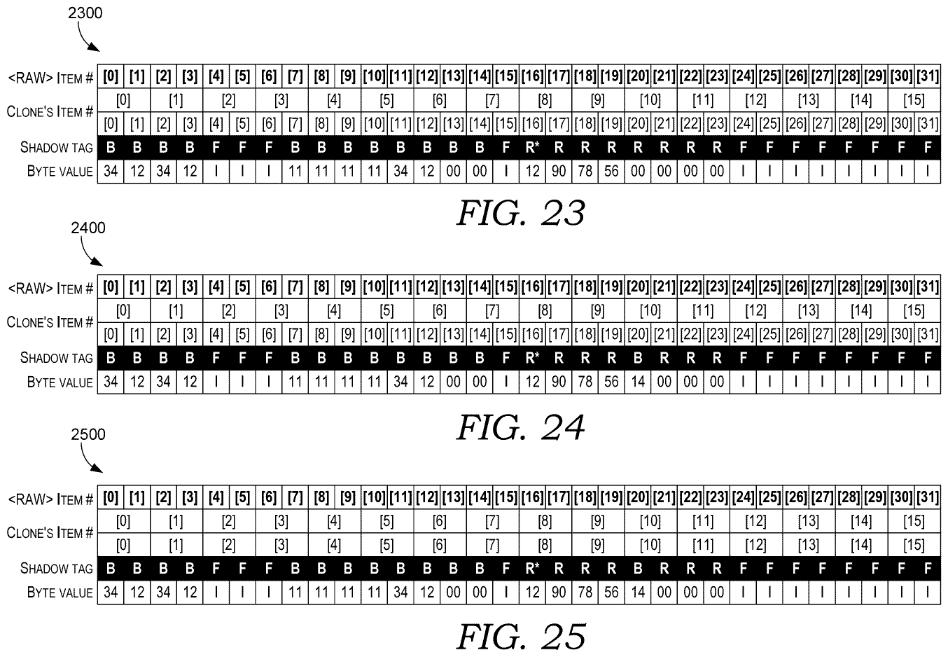

With reference now to FIG. 23, and as executed by the instructions below, the first instruction assigns the <RADT> which was stored in the previous instruction, into GP3. After this instruction, GP3 and GP1 will be identical. However, any instruction which affects the offsets or view via GP1 or GP3 will also apply to other, as they both use the same token and have the same pointer. Instead, an additional clone may be created from the original buffer or from an existing clone so each copy has a token for its private use. Importantly, for this move to be allowed and not violate the security boundary, the SMART processor follows the following steps: 1) the tag associated with the view must be <RADT>; 2) the first byte of the target must have a shadow tag of *R indicating the first byte of an <RADT> has previously been stored here; and 3) the following 7 bytes must all have a shadow tag of R, indicating they have not been overwritten since they were written as an <RADT>. If any of these assertions fail, an exception is raised. The second instruction clones GP2 back to its initial <RAW> view. The resulting <RAW> item #s, CLONE item #s, shadow tags, and byte values are illustrated by 2300.

MOV GP3, GP2.PTR
CLONE GP2, GP0

In FIG. 24, and as executed by the instructions below, the first instruction sets the offset to [20]. Next, the second instruction changes GP2's offset to [20] which is in the middle of a stored <RADT>. The third instruction causes the value (0x14) where GP3 [20] currently points to be stored where GP2 currently points [20]. This is allowed to afford maximum flexibility to the <RAW> storage. Note that this has also invalidated the <RADT> previously stored in [16]-[23] because not all bytes indicate <RADT>. Also note that bytes [16]-[19] and [21]-[23] are no longer readable even if a clone's view is <RADT>, since at least one of the three required assertions will fail. The resulting <RAW> item #s, CLONE item #s, shadow tags, and byte values are illustrated by 2400.

| | |
|---|---|
| LTRL | GP3, 0x14 |
| SETOFF | GP2, GP3 |
| MOV | GP2.PTR, GP3 |

Turning to FIG. 25, and as executed by the instructions below, since GP2 is still pointing to [20] with a view <RAW>, the first instruction causes a single byte to be read (and the tag is not <RADT>) so GP3's value is set to 0x14 with a tag of <U8>. Next, the second instruction defines a tag of <U16>. The third instruction changes GP2's view to all items of <U16>. The resulting <RAW> item #s, CLONE item #s, shadow tags, and byte values are illustrated by 2500.

| | |
|---|---|
| MOV | GP3, GP2.PTR |
| LTRL | GP8, <U8> 0x82 |
| ITYPE | GP2, GP8 |

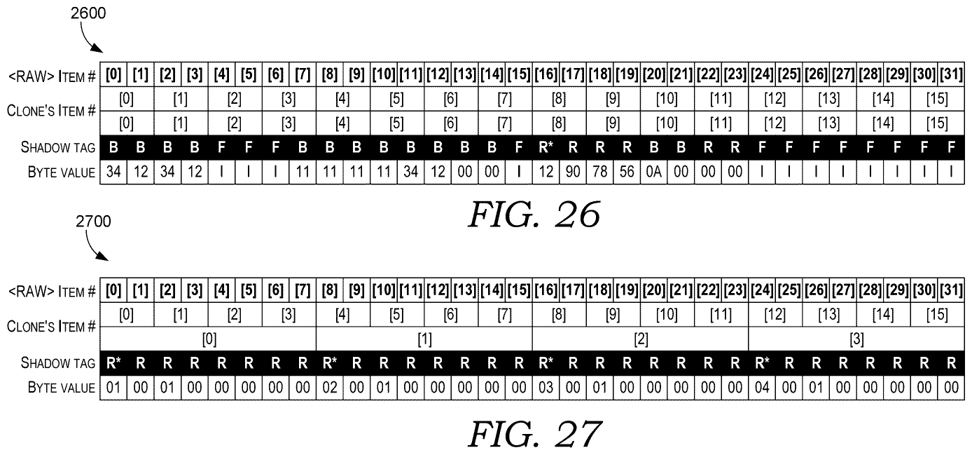

Referring to FIG. 26, and as executed by the instructions below, the first instruction sets the value of GP8 to [10] which indicates the item number in the subsequent LDITEM instruction. Next, the second instruction raises an exception because one of the bytes is not B. Note, this check also covers the case of <FWINT>. The third instruction is invalid as the CLONE's view is <U16> and GP8 is <U8>. GP8's value is zero extended to 0x000A and the value may be stored into [10] overwriting another byte of the abandoned <RADT>. The resulting <RAW> item #s, CLONE item #s, shadow tags, and byte values are illustrated by 2600.

LTRL GP8, <U8> 0x0A
LDITEM GP3, GP2.PTR, GP8
STITEM GP2.PTR, GP8, GP8

Finally, in FIG. 27, and as executed by the instructions below, four clones are created, each with a different view of the <RAW> #storage (<U8>, <U16>, <U32>, and <U64>). The pointer's<RADT> values will be stored into the <RAW> area in sequence starting at [0]. The first instruction clones the <RAW> buffer into GP2 and the offset is 0. Assume this clone's <RADT> is 0x10000 and that the <RADT> of the clones created in the loop will be 0x10001 through 0x10004. Next, the second instruction defines a tag of <RADT> and GP3 is used to store the clones. The third instruction causes GP3 to view <RAW> as <RADT>. Finally, the fourth instruction defines of tag of <U8>.

In the loop, the first instruction creates a new clone of <RAW>. Next, the second instruction sets the type to the current tag represented in GP8. The third instruction, the new clone's<RADT> is moved into the item where GP2 currently points. Next, the fourth instruction increments the tag value in GP8. The fifth instruction advances to the next tag type. Next, the sixth instruction advance to next item in GP2's<RADT> view. The seventh instruction defines a tag of <U64>. Finally, the last two instructions determine whether the loop should be exited or continued.

| CLONE | GP2, GP0 |
|---|---|
| LTRL | GP8, 0x1B |
| ITYPE | GP2, GP8 |
| LTRL | GP8, 0x81 |
| AGAIN: | |
| CLONE | GP9, GP0 |
| ITYPE | GP9, GP8 |
| MOV | GP2.PTR, GP9 |
| LTRL | GP9, <U8> 1 |
| ADD | GP8, GP8, GP9 |
| INCOFF | GP2 |
| LTRL | GP9, <U8> 0x84 |
| LSEQ | GP9, GP8, GP9 |
| JTRABS | AGAIN, GP9 |

DONE:

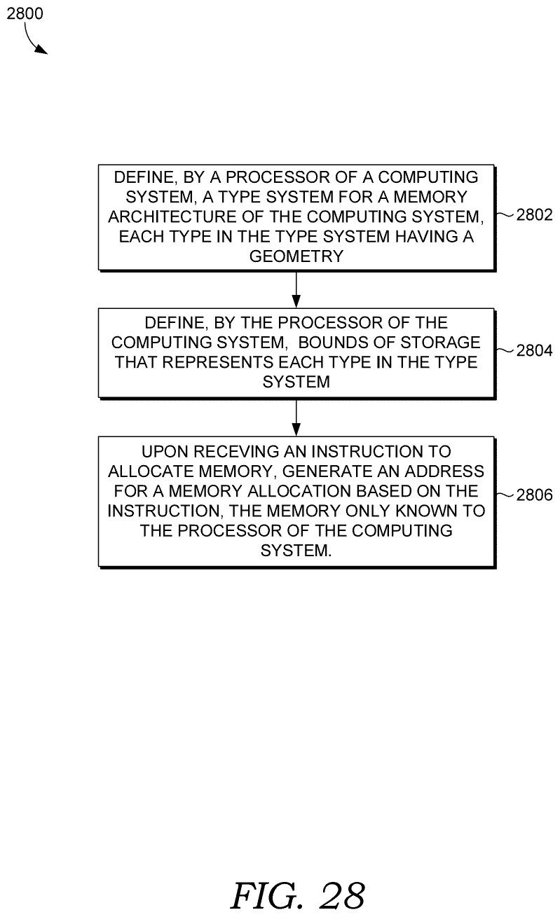

FIG. 28 is a flow diagram showing a method 2800 of an example process flow for enabling opaque addresses in SMART processor, in accordance with some implementations of the present disclosure. The method 2800 can be performed, for instance, by the hosted computing environment 120 of FIG. 1. Each block of the methods 2800, 2900, and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at step 2802, a type system for the memory architecture is defined by a processor of the computing system. Each type in the type system has a geometry. At step 2804, bounds of storage that represents each type in the type system is also defined by the processor of the computing system.

At step 2806, upon receiving an instruction to allocate memory within the memory architecture, an address for a memory allocation is generated based on the instruction. The address is known only to the processor of the computing system. In this way, software running on the processor is unable to acquire an address corresponding to data stored for the software. The instruction may include a tag that defines the type of memory for the memory allocation.

In some aspects, a second instruction from software executing on the processor is received. The second instruction may be to read data corresponding to memory of the memory allocation. If read is allowed for the memory and the software, the software is enabled to read the data corresponding to the memory.

In some aspects, a second instruction from software executing on the processor is received. In these aspects, the second instruction may be to write data corresponding to memory of the memory allocation. If write is allowed for the memory and the software, the software is enabled to write the data corresponding to the memory.

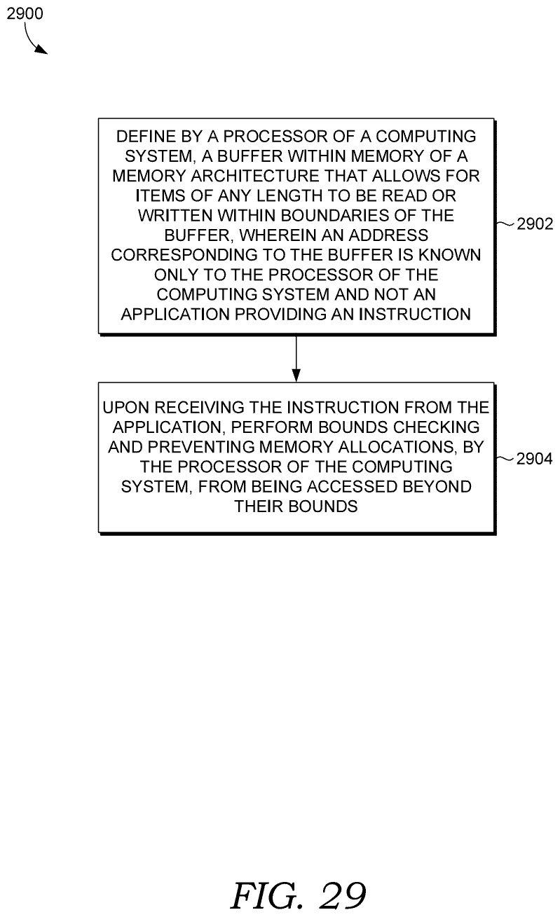

FIG. 29 is a flow diagram showing a method 2900 of an example process flow for enabling optimizations in a SMART architecture, in accordance with some implementations of the present disclosure. At block 2902, a buffer within memory of the memory architecture that allows for items of any length to be read or written within boundaries of the buffer is defined by a processor of the computing system. An address corresponding to the buffer is known only to the processor of the computing system and not an application providing an instruction. In aspects, the buffer provides a sequential range of addresses, enabling a compiler to perform address calculations.

At step 2904, upon receiving the instruction from the application, bounds checking is performed by the processor of the computing system. Moreover, memory allocations are prevented, by the processor of the computing system, from being accessed beyond their bounds. Upon receiving a second instruction to allocate memory for the buffer, the processor may define each item in the buffer as a byte. Additionally or alternatively, any item type is enabled by the processor to be read or written into a range of adjacent bytes of the buffer.

In some aspects, contents of the buffer is based on a parallel allocation of memory providing a shadow type indicator. The shadow type indicator may track types of items stored into buffer. Based on types outside of the buffer known to the processor, the processor is able to track a type that was last written into each byte of the buffer.

In some aspects, the processor enforces a security model on all loads and stores into the buffer. Upon an item being loaded from the buffer into a register or alternate storage type, the processor may validate that a type the instruction stipulates as the type to be assigned to the loaded item does not violate the security model of the computing system. Upon the processor detecting a violation of the security model of the computing system, an exception is raised on an instruction executing a load.

Having described embodiments of the present disclosure, FIG. 30 provides an example of a computing device in which embodiments of the present disclosure may be employed. Computing device 3000 includes bus 3002 that directly or indirectly couples the following devices: memory 3004, one or more processors 3006, one or more presentation components 3008, input/output (I/O) ports 3010, input/output components 3012, and power supply 3014. Bus 3002 represents what may be one or more buses (such as an address bus, data bus, or combination thereof). Although the various blocks of FIG. 30 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 30 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 30 and reference to “computing device.”

Computing device 3000 typically includes a variety of computer-readable media. Computer-readable media can be any available media that can be accessed by computing device 900 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium that can be used to store the desired information and which can be accessed by computing device 3000. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 3004 includes computer storage media in the form of volatile and/or nonvolatile memory. Memory 3004 may include instructions (not shown in FIG. 30). Instructions, when executed by processor(s) 3006 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 3000 includes one or more processors that read data from various entities such as memory 3004 or I/O components 3012. Presentation component(s) 3008 present data indications to a user or other device. Exemplary presentation components include a display device, speaker, printing component, vibrating component, etc.

I/O ports 3010 allow computing device 3000 to be logically coupled to other devices including I/O components 3012, some of which may be built in. Illustrative components include a microphone, joystick, game pad, satellite dish, scanner, printer, wireless device, etc. I/O components 3012 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 3000. Computing device 3000 may be equipped with depth cameras, such as stereoscopic camera systems, infrared camera systems, RGB camera systems, and combinations of these, for gesture detection and recognition. Additionally, computing device 3000 may be equipped with accelerometers or gyroscopes that enable detection of motion. The output of the accelerometers or gyroscopes may be provided to the display of computing device 3000 to render immersive augmented reality or virtual reality.

Embodiments presented herein have been described in relation to particular embodiments that are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order to not obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C); (A and B); (A and C); (B and C); or (A, B and C).”

1. A method corresponding to a memory architecture in a computing system, comprising:
defining, by a processor of the computing system, a buffer within memory of the memory architecture that allows for items of any length to be read or written within boundaries of the buffer, wherein an address corresponding to the buffer is known only to the processor of the computing system and not an application providing an instruction, and wherein the processor maintains a parallel shadow memory that stores a type indicator for each portion of the buffer; and
upon receiving the instruction from the application, performing bounds checking and validating a data type of any accessed item using the type indicator stored in the shadow memory, thereby preventing memory allocations, by the processor of the computing system, from being accessed beyond their bounds or in violation of a security model.

2. The method of claim 1, wherein the buffer provides a sequential range of addresses, enabling a compiler to perform address calculations.

3. The method of claim 1, further comprising, upon receiving a second instruction to allocate memory for the buffer, defining, by the processor, each item in the buffer as a byte.

4. The method of claim 1, further comprising enabling, by the processor, any item type to be read or written into a range of adjacent bytes of the buffer.

5. The method of claim 1, wherein contents of the buffer is based on a parallel allocation of memory providing the shadow type indicator.

6. The method of claim 5, wherein the shadow type indicator tracks types of items stored into buffer.

7. The method of claim 1, based on types outside of the buffer known to the processor, tracking, by the processor, a type that was last written into each byte of the buffer.

8. The method of claim 1, further comprising, enforcing, by the processor, a security model on all loads and stores into the buffer.

9. The method of claim 8, further comprising, upon an item being loaded from the buffer into a register or alternate storage type, validating, by the processor, that a type the instruction stipulates as the type to be assigned to the loaded item does not violate the security model of the computing system.

10. The method of claim 9, further comprising, upon detecting, by the processor, a violation of the security model of the computing system, raising an exception on an instruction executing a load.

11. One or more computer storage media having executable instructions embodied thereon, which, when executed by a processor, cause the processor to perform operations to a memory architecture in a computing system, the operations comprising:
defining, by a processor of the computing system, a buffer within memory of the memory architecture that allows for items of any length to be read or written within boundaries of the buffer, wherein an address corresponding to the buffer is known only to the processor of the computing system and not an application providing an instruction, and wherein the processor maintains a parallel shadow memory that stores a type indicator for each portion of the buffer; and
upon receiving the instruction from the application, performing bounds checking and validating a data type of any accessed item using the type indicator stored in the shadow memory, thereby preventing memory allocations, by the processor of the computing system, from being accessed beyond their bounds or in violation of a security model.

12. The media of claim 11, wherein the buffer provides a sequential range of addresses, enabling a compiler to perform address calculations.

13. The media of claim 11, further comprising, upon receiving a second instruction to allocate memory for the buffer, defining, by the processor, each item in the buffer as a byte.

14. The media of claim 11, further comprising enabling, by the processor, any item type to be read or written into a range of adjacent bytes of the buffer.

15. The media of claim 11, wherein contents of the buffer is based on a parallel allocation of memory providing the shadow type indicator.

16. The media of claim 15, wherein the shadow type indicator tracks types of items stored into buffer.

17. The media of claim 11, based on types outside of the buffer known to the processor, tracking, by the processor, a type that was last written into each byte of the buffer.

18. The media of claim 11, further comprising, enforcing, by the processor, a security model on all loads and stores into the buffer.

19. The media of claim 18, further comprising:
upon an item being loaded from the buffer into a register or alternate storage type, validating, by the processor, that a type the instruction stipulates as the type to be assigned to the loaded item does not violate the security model of the computing system; and
upon detecting, by the processor, a violation of the security model of the computing system, raising an exception on an instruction executing a load.

20. A system comprising:
a processor; and
a memory architecture in a computing system coupled to the processor storing instructions that, as a result of being executed by the processor, cause the processor to:
define, by a processor of the computing system, a buffer within memory of the memory architecture that allows for items of any length to be read or written within boundaries of the buffer, wherein an address corresponding to the buffer is known only to the processor of the computing system and not an application providing an instruction, and wherein the processor maintains a parallel shadow memory that stores a type indicator for each portion of the buffer; and
upon receiving the instruction from the application, perform bounds checking and validate a data type of any accessed item using the type indicator stored in the shadow memory, thereby preventing memory allocations, by the processor of the computing system, from being accessed beyond their bounds or in violation of a security model.
